(19) United States
(12) Patent Application Publication
(10) Pub. No.: US 2011/0231621 A1
(43) Pub. Date: Sep. 22, 2011

(54) SYSTEM RECOVERY METHOD, AND STORAGE MEDIUM CONTROLLER AND STORAGE SYSTEM USING THE SAME

(75) Inventor: Ming-Jen Liang, Hsinchu City (TW)

(73) Assignee: PHISON ELECTRONICS CORP., Miaoli (TW)

(21) Appl. No.: 12/777,493

(22) Filed: May 11, 2010

(30) Foreign Application Priority Data
Mar. 22, 2010 (TW) 99108359

(51) Int. Cl. G06F 12/00

(52) U.S. Cl. 711/155; 711/E12.001

(57) ABSTRACT

A system recovery method is provided. The system recovery method includes grouping storage addresses corresponding to a storage device into a first memory area and a second memory area. The system recovery method also includes storing initial data from a host system into the storage addresses of the first memory area, storing update data for updating the initial data into the storage addresses of the second memory area, and establishing an address corresponding table to record update information corresponding to the storage addresses for storing the update data. The system recovery method further includes erasing the update information from the address corresponding table when the storage device is powered off and re-coupled to the host system. Thereby, the system recovery method can instantly recover system settings.

### CROSS-REFERENCE TO RELATED APPLICATION

This application claims the priority benefit of Taiwan application serial no. 99108359, filed on Mar. 22, 2010. The entirety of the above-mentioned patent application is hereby incorporated by reference herein and made a part of this specification.

### BACKGROUND

1. Technology Field

The present invention relates to a system recovery method and a storage medium controller and a storage system using the same.

2. Description of Related Art

A storage device in a computer system is used for storing data. Particularly, when a storage device is used as a system disc (also known as a primary disc), the storage space of the storage device is used for installing an operation system (OS) and storing system setting data. During the operation of a system disc, the system setting data stored in the system disc may be falsified or damaged due to a human error, a virus infection, or a hacker intrusion. Taking an educational computer deployed in a computer classroom or an industrial computer as an example, when a student or an operator uses the computer, he or she may change related settings or even execute a program containing a virus. Thus, after installing the OS and application programs, a computer administrator may wish that the computer is always restored to its original state every time after the computer is used so that the computer is protected from improper operation and re-setting or re-installing the OS or the application programs is made unnecessary.

In order to achieve this purpose, the computer administrator may set the system disc to be at a write-protect mode to prevent unauthorized user from writing data into the system disc. However, because the OS may need to write a log file into the system disc when the computer is boot up, the OS may not successfully starts when the system disc is set to be at the write-protect mode. Thus, such a technique can only be applied to a specific OS or requires the settings of the OS to be changed.

In addition, according to another technique, a backup storage area is divided from the storage space of a system disc, and the image file of a default OS or an application program is stored into this backup storage area. Subsequently, the image file is loaded from the backup storage area into the boot sector to overwrite the OS or application program in the system disc every time when the computer is boot up. However, in this technique the settings of the basic input/output system (BIOS) are needed to tailor to support this function. Besides, if the image file is very large, the time for loading the image file prolongs the boot-up time of the computer and accordingly reduces the system performance.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

Accordingly, the present invention is directed to a system recovery method that can instantly recover system settings.

The present invention is also directed to a storage medium controller that can instantly recover system settings.

The present invention is further directed to a storage system that can instantly recover system settings.

According to an exemplary embodiment of the present invention, a system recovery method for a storage device is provided. The system recovery method includes grouping a plurality of storage addresses corresponding to the storage device into at least a first memory area and a second memory area and receiving at least a first write command and a first data from a host system. The system recovery method also includes writing a first data into the storage addresses of the second memory area when the first data is to be written into the storage addresses of the first memory area. The system recovery method also includes establishing an address corresponding table to record update information corresponding to the storage addresses for storing the first data. The system recovery method further includes erasing the update information from the address corresponding table when the storage device is powered off and re-coupled to the host system.

According to an exemplary embodiment of the present invention, a storage medium controller for managing a storage medium unit is provided, wherein the storage medium unit has a plurality of storage addresses. The storage device includes a host interface, a storage medium interface, and a storage medium management circuit. The host interface is coupled to the storage medium management circuit and used for coupling to a host system. The storage medium interface is coupled to the storage medium management circuit and used for coupling to the storage medium unit. The storage medium management circuit is configured for executing the system recovery method described above.

According to an exemplary embodiment of the present invention, a storage system including a connector, a storage medium unit, and a storage medium controller is provided. The connector is configured for coupling to a host system. The storage medium unit has a plurality of storage addresses. The storage medium controller is coupled to the storage medium unit and the connector and configured for executing the system recovery method described above.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

As described above, according to exemplary embodiments of the present invention, system settings can be instantly and effectively recovered so that any incorrect change of the system settings or damage to a system file caused by human error, virus infection, or hacker intrusion can be prevented.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a host system using a storage device according to an exemplary embodiment of the present invention.

FIG. 1B is a diagram of a computer, an input/output (I/O) device, and a storage device according to an exemplary embodiment of the present invention.

FIG. 1C is a diagram of a host system and a storage device according to another exemplary embodiment of the present invention.

FIG. 2 is a schematic block diagram of the storage device in FIG. 1A.

FIG. 3 is a schematic block diagram of a storage medium controller according to an exemplary embodiment of the present invention.

FIG. 4 is a diagram of managing a storage medium unit according to an exemplary embodiment of the present invention.

FIG. 5 is a diagram of managing a storage area according to an exemplary embodiment of the present invention.

FIG. 6 illustrates an example of writing data according to an exemplary embodiment of the present invention.

FIG. 7 illustrates another example of writing data according to an exemplary embodiment of the present invention.

FIG. 8 illustrates an example of an address corresponding table according to an exemplary embodiment of the present invention.

FIG. 9 is a flowchart illustrating the steps of dividing a storage medium and establishing an address corresponding table in a system recovery method according to an exemplary embodiment of the present invention.

FIG. 10 is a flowchart illustrating the steps of writing and reading data in a system recovery method according to an exemplary embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

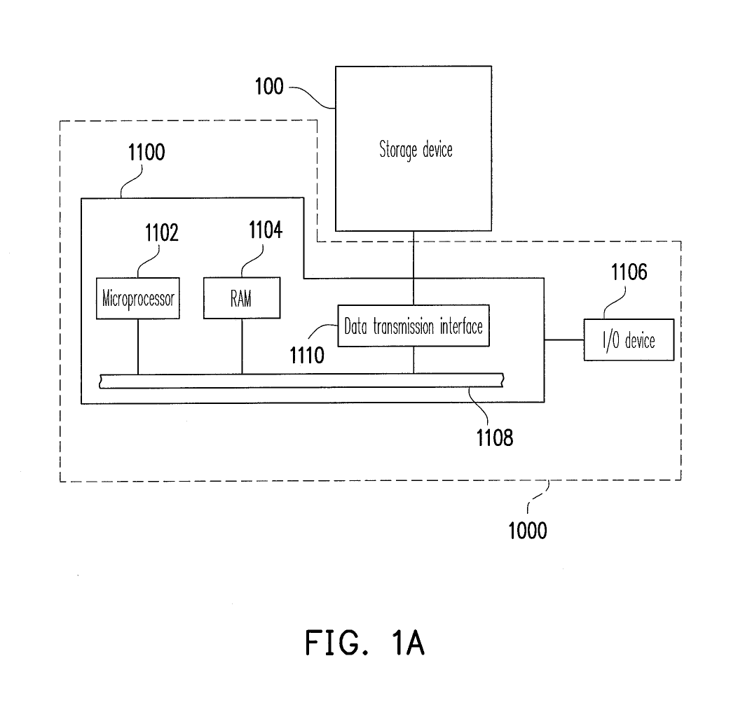

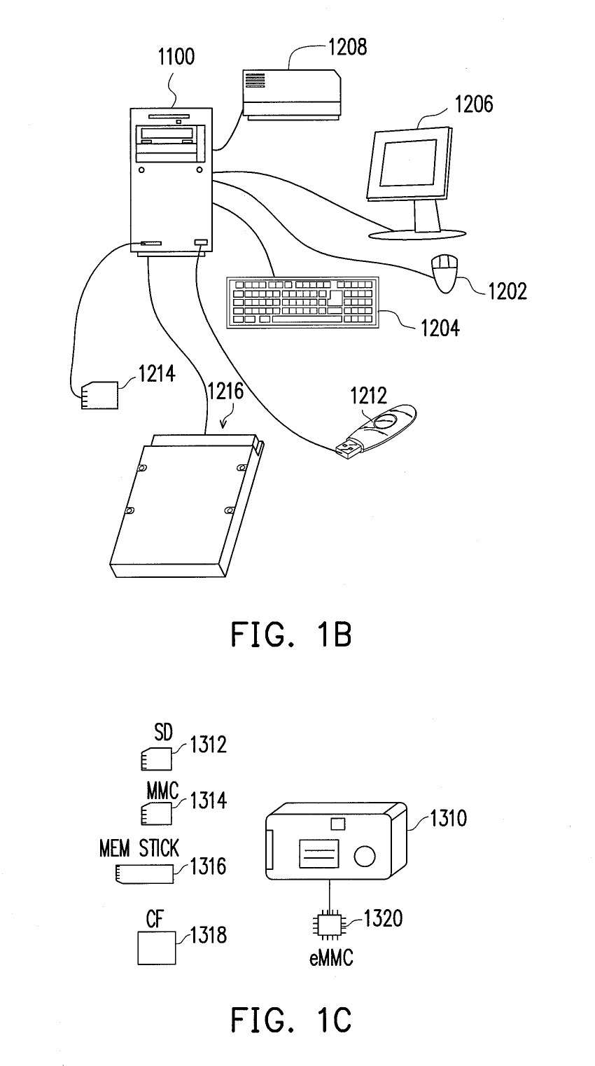

FIG. 1A is a block diagram of a host system using a storage device according to an exemplary embodiment of the present invention.

Referring to FIG. 1A, the host system 1000 includes a computer 1100 and an input/output (I/O) device 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206, and a printer 1208, as shown in FIG. 1B. However, the I/O device 1106 is not limited to the devices illustrated in FIG. 1B, and may further include other devices.

In the present exemplary embodiment, a storage device 100 is coupled to other components of the host system 1000 through the data transmission interface 1110. Data can be written into or read from the storage device 100 through the operations of the microprocessor 1102, the RAM 1104, and the I/O device 1106. For example, the storage device 100 may be the flash drive 1212, the memory card 1214, or the solid state drive (SSD) 1216 illustrated in FIG. 1B.

Generally speaking, the host system 1000 may be substantially any system that can store data. Even though the host system 1000 is described as a computer system in the present exemplary embodiment, the host system 1000 may also be a digital camera, a video camera, a communication device, an audio player, or a video player in another exemplary embodiment of the present invention. For example, if the host system 1000 is the digital camera (video camera) 1310, the storage device is then a SD card 1312, a MMC card 1314, a memory stick 1316, a CF card 1318, or an embedded storage device 1320 compatible to the digital camera 1310 (as shown in FIG. 1C). The embedded storage device 1320 includes an embedded MMC (eMMC). It should be mentioned that the eMMC is directly coupled to the substrate of the host system.

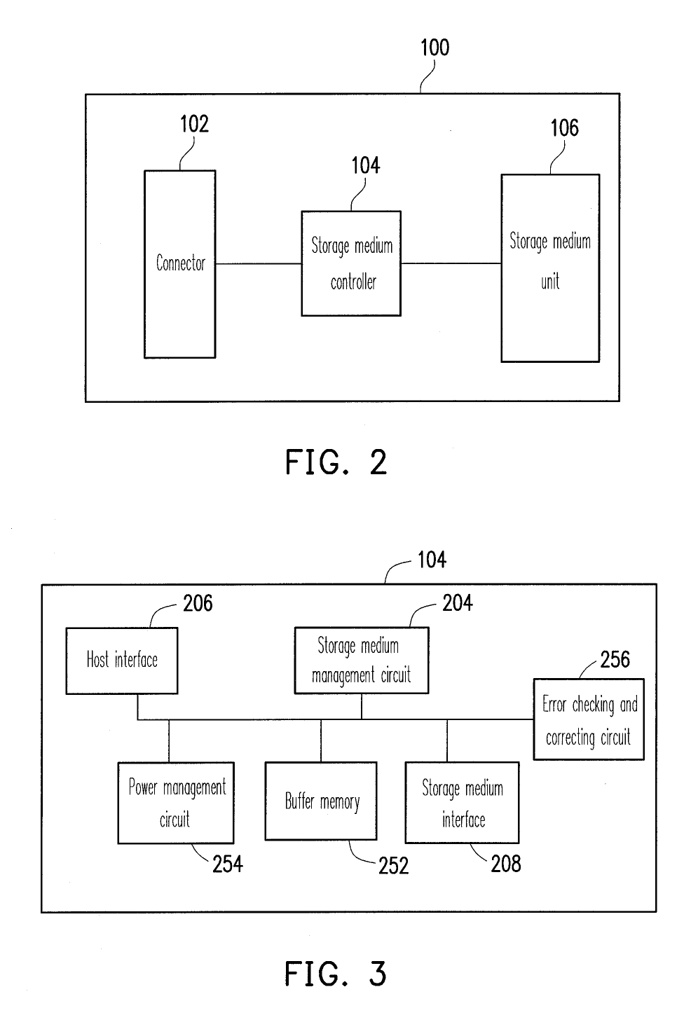

FIG. 2 is a schematic block diagram of the storage device in FIG. 1A.

Referring to FIG. 2, the storage device 100 includes a connector 102, a storage medium controller 104, and a storage medium unit 106.

The connector 102 is coupled to the storage medium controller 104 and used for coupling to the host system 1000. In the present exemplary embodiment, the connector 102 is a serial advanced technology attachment (SATA) connector. However, the present invention is not limited thereto, and the connector 102 may also be a universal serial bus (USB) connector, an Institute of Electrical and Electronic Engineers (IEEE) 1394 connector, a peripheral component interconnect (PCI) express connector, a secure digital (SD) interface connector, a memory stick (MS) interface connector, a multi media card (MMC) interface connector, a compact flash (CF) interface connector, an integrated device electronics (IDE) connector, or other suitable connectors.

The storage medium controller 104 executes a plurality of logic gates or control instructions implemented in a hardware or firmware form and performs operations of writing and reading data on the storage medium unit 106 according to commands of the host system 1000.

FIG. 3 is a schematic block diagram of a storage medium controller according to the exemplary embodiment of the present invention.

Referring to FIG. 3, the storage medium controller 104 includes a storage medium management circuit 204, a host interface 206, and a storage medium interface 208.

The storage medium management circuit 204 controls the operation of the storage medium controller 104. To be specific, the storage medium management circuit 204 has a plurality of control instructions, and when the storage device 100 is in operation, the storage medium management circuit 204 executes the control instructions to manage the storage medium unit 106 according to a data access mechanism and a storage medium management mechanism in the present exemplary embodiment. Below, the data access mechanism and the storage medium management mechanism will be described in detail with reference to accompanying drawings.

In the present exemplary embodiment, the storage medium management circuit 204 is implemented in a firmware form. For example, the storage medium management circuit 204 has a microprocessor unit (not shown) and a read only memory (ROM, not shown), and the control instructions are burnt into the ROM. When the storage device 100 is in operation, the control instructions are executed by the microprocessor unit to accomplish the data access mechanism and the storage medium management mechanism in the present exemplary embodiment.

In another exemplary embodiment of the present invention, the control instructions of the storage medium management circuit 204 may also be stored in a specific area (for example, the system area exclusively used for storing system data in a memory chip) of the storage medium unit 106 as program codes. In addition, the storage medium management circuit 204 has a microprocessor unit (not shown), a ROM (not shown), and a random access memory (RAM, not shown). Particularly, the ROM has a driving code segment, and when the storage medium controller 104 is enabled, the microprocessor unit first executes the driving code segment to load the control instructions of the storage medium management circuit 204 from the storage medium unit 106 into the RAM of the storage medium management circuit 204 and then executes the control instructions to execute the data access mechanism and the storage medium management mechanism in the present exemplary embodiment. Additionally, in another exemplary embodiment of the present invention, the control instructions of the storage medium management circuit 204 may also be implemented in a hardware form.

The host interface 206 is coupled to the storage medium management circuit 204 and receives and identifies commands and data received from the host system 1000. Namely, the commands and data received from the host system 1000 are sent to the storage medium management circuit 204 through the host interface 206. In the present exemplary embodiment, the host interface 206 is a SATA interface corresponding to the connector 102. However, the present invention is not limited thereto, and the host interface 206 may also be a PATA interface, a USB interface, an IEEE 1394 interface, a PCI express interface, a SD interface, a MS interface, a MMC interface, a CF interface, an IDE interface, or other suitable data transmission interface.

The storage medium interface 208 is coupled to the storage medium management circuit 204 and accesses the storage medium unit 106. Namely, data to be written into the storage medium unit 106 is converted by the storage medium interface 208 into a format acceptable to the storage medium unit 106.

In an exemplary embodiment of the present invention, the storage medium controller 104 still includes a buffer memory 252. The buffer memory 252 is coupled to the storage medium management circuit 204 and temporarily stores data and commands from the host system 1000 or data from the storage medium unit 106.

In an exemplary embodiment of the present invention, the storage medium controller 104 still includes a power management circuit 254. The power management circuit 254 is coupled to the storage medium management circuit 204 and controls the power supply of the storage device 100.

In an exemplary embodiment of the present invention, the storage medium controller 104 still includes an error checking and correcting circuit 256. The error checking and correcting circuit 256 is coupled to the storage medium management circuit 204 and executes an error checking and correcting procedure to ensure data accuracy. To be specific, when the storage medium management circuit 204 receives a write command from the host system 1000, the error checking and correcting circuit 256 generates an error checking and correcting (ECC) code for the data corresponding to the write command, and the storage medium management circuit 204 writes the data and the corresponding ECC code into the storage medium unit 106. Subsequently, when the storage medium management circuit 204 reads the data from the storage medium unit 106, it also reads simultaneously the ECC code corresponding to the data, and the error checking and correcting circuit 256 executes the error checking and correcting procedure on the read data according to the ECC code.

Referring to FIG. 2 again, the storage medium unit 106 is coupled to the storage medium controller 104 and used for storing data. In the present exemplary embodiment, the storage medium unit 106 is a re-writable non-volatile memory module and has a plurality of physical blocks. Each of the physical blocks has a plurality of physical pages. The physical pages corresponding to the same physical block can be individually written but have to be erased all together. To be specific, each physical block is the smallest unit for erasing data. Namely, each physical block contains the least number of memory cells that are erased together. Each physical block has a plurality of physical pages, and each physical page is the smallest unit for programming data. In other words, each physical page is the smallest unit for writing or reading data. Each physical page usually includes a user data bit area and a redundant bit area, wherein the user data bit area is used for storing user data, and the redundant bit area is used for storing system data (for example, the ECC code). The storage medium unit 106 may be a flash memory chip. However, the present invention is not limited thereto, and the storage medium unit 106 may also be other rewritable non-volatile memory chips, a disc, or other storage media.

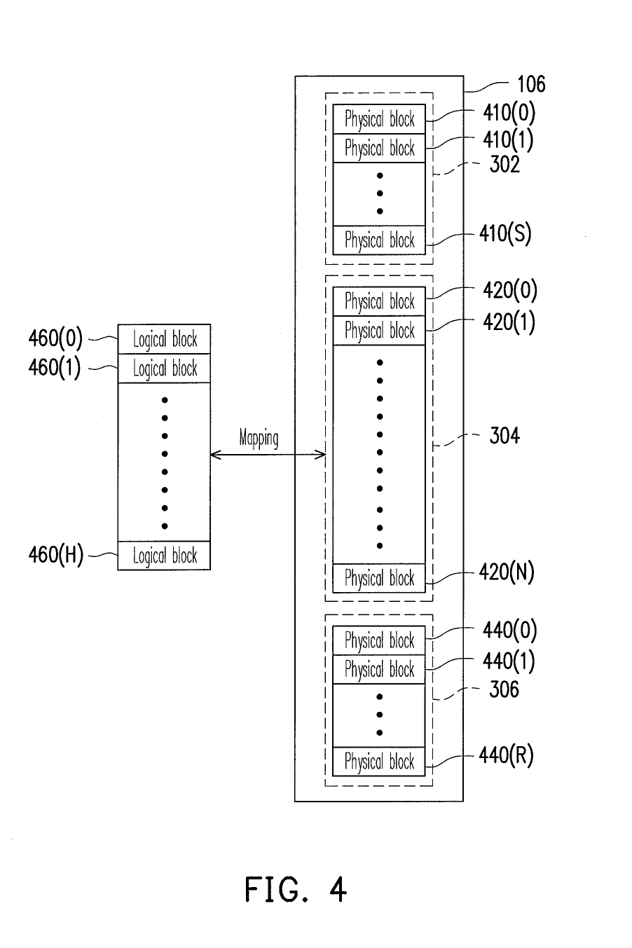

FIG. 4 is a diagram of managing the storage medium unit according to the exemplary embodiment of the present invention.

The storage medium management circuit 204 of the storage medium controller 104 logically groups the physical blocks of the storage medium unit 106 into a system area 302, a storage area 304, and a replacement area 306.

The physical blocks 410(0)-410(S) logically belonging to the system area 302 are used for recording system data, such as the manufacturer and model of the storage medium unit 106, the number of physical blocks in the storage medium unit 106, and the number of physical pages in each physical block.

The physical blocks 420(0)-420(N) logically belonging to the storage area 304 are used for storing data to be written by the host system 1000. Namely, the storage device 100 uses the physical blocks in the storage area 304 for actually storing data to be written by the host system 1000.

In particular, the storage medium management circuit 204 groups the physical blocks in the storage area 304 into a data area and a spare area (not shown). In addition, when the storage medium management circuit 204 is about to write data into the storage area 304, the storage medium management circuit 204 uses the physical blocks in the data area and the spare area alternatively for writing the data. For example, when the storage medium management circuit 204 is about to write data into the storage area 304, the storage medium management circuit 204 gets a physical block from the spare area for writing the data, so as to replace a physical block in the data area. In order to allow the host system 1000 to smoothly access the physical blocks that are alternatively used for storing data, the storage medium management circuit 204 provides logical blocks 460(0)-460(H) mapped to the physical blocks of the storage area 304 for accessing by the host system 1000. To be specific, the host system 1000 simply gives a data access command according to the logical blocks 460(0)-460(H), while the storage medium management circuit 204 actually writes data into the mapped physical blocks according to the data access command and a logical block-physical block mapping table. Herein the logical blocks are also referred to as storage addresses.

The physical blocks 440(0)-440(R) logically belonging to the replacement area 306 are replacement physical blocks. For example, when the storage medium unit 106 is manufactured, 4% of its physical blocks are reserved for replacement purpose. Namely, when a physical block in the system area 302 or the storage area 304 is damaged, a physical block reserved in the replacement area 306 is used for replacing the damaged physical block (i.e., bad block). Thus, if there are still normal physical blocks in the replacement area 306 and a physical block is damaged, the storage medium management circuit 204 gets a normal physical block from the replacement area 306 for replacing the damaged physical block. If there is no normal physical block in the replacement area 306 and a physical block is damaged, the storage device 100 is announced as being at a write-protected status and cannot be used for writing data anymore.

In particular, the numbers of physical blocks in the system area 302, the storage area 304, and the replacement area 306 are various based on different memory modules. In addition, it should be understood that during the operation of the storage device 100, the grouping relationships of grouping the physical blocks into the system area 302, the storage area 304, and the replacement area 306 are changed dynamically. For example, when a physical block in the storage area 304 is damaged and accordingly is replaced by a physical block in the replacement area 306, the physical block originally in the replacement area 306 is then associated to the storage area 304.

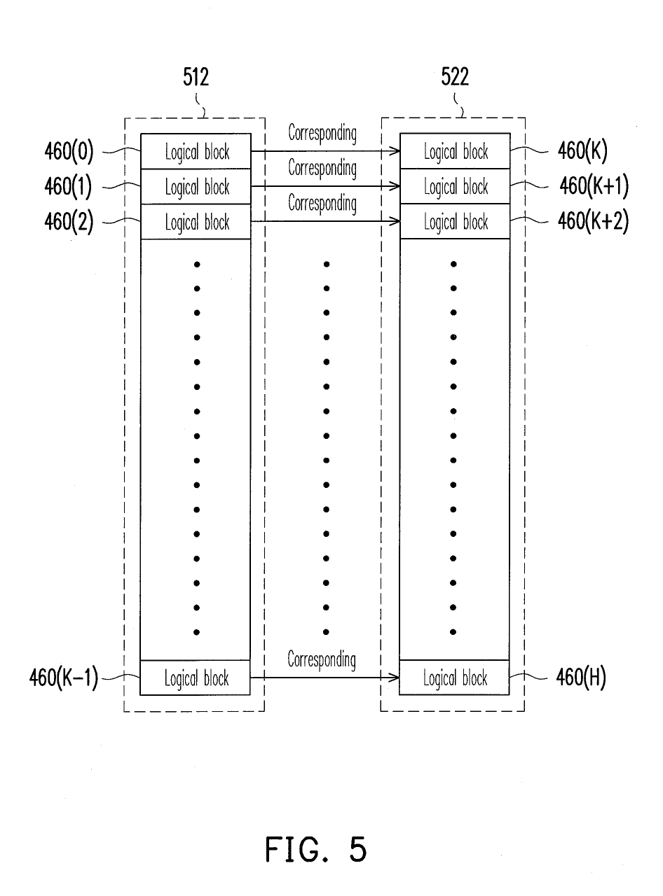

FIG. 5 is a diagram of managing the storage area according to the exemplary embodiment of the present invention.

Referring to FIG. 5, according to the storage medium management mechanism in the present exemplary embodiment, the storage medium management circuit 204 groups the logical blocks 460(0)-460(K−1) of the storage area 304 into a first memory area 512 (referred to as a primary memory area 512 thereinafter) and groups the logical blocks 460(K)-460(H) into a second memory area 522 (referred to as a temporary memory area 522 thereinafter).

Additionally, the storage medium management circuit 204 respectively maps the logical blocks 460(K)-460(H) in the temporary memory area 522 to the logical blocks 460(0)-460(K−1) in the primary memory area 512 and serves the logical blocks 460(K)-460(H) in the temporary memory area 522 as the temporary addresses of the logical blocks in the primary memory area 512.

The storage medium management circuit 204 provides the primary memory area 512 but not the temporary memory area 522 to the host system 1000. For example, assuming that the capacity of the storage area 304 is 4 gigabytes (4 G), the storage medium management circuit 204 groups a half of the logical blocks into the primary memory area 512 and another half of the logical blocks into the temporary memory area 522. When the storage device 100 is coupled to the host system 1000 and receives a storage medium feature inquiry command, the storage medium management circuit 204 sends a message indicating that “the storage device 100 is a large-capacity storage device” and a message indicating that “the storage space is the primary memory area 512 (i.e., a storage space of 2 G)” to the host system 1000. Namely, the host system 1000 only recognizes the primary memory area 512 and accesses data in the primary memory area 512. In particular, the host system 1000 cannot get to know about the existence of the temporary memory area 522.

In the present exemplary embodiment, the storage medium management circuit 204 sets the storage mode of the primary memory area 512 to a writable mode or a write-protect mode according to a control command (for example, a vendor command) given by the host system 1000.

In particular, in the case that the storage mode of the primary memory area 512 is set to the writable mode, when the storage medium management circuit 204 receives a write command from the host system 1000, the storage medium management circuit 204 writes the data corresponding to the write command into the primary memory area 512. In the case that the storage mode of the primary memory area 512 is set to the write-protect mode, when the storage medium management circuit 204 receives a write command from the host system 1000, the storage medium management circuit 204 writes the data corresponding to the write command into the temporary memory area 522.

Namely, in the case that the storage mode of the primary memory area 512 is set to the write-protect mode, the storage medium management circuit 204 writes the data that is to be written into logical blocks of the primary memory area 512 into the corresponding logical blocks of the temporary memory area 522.

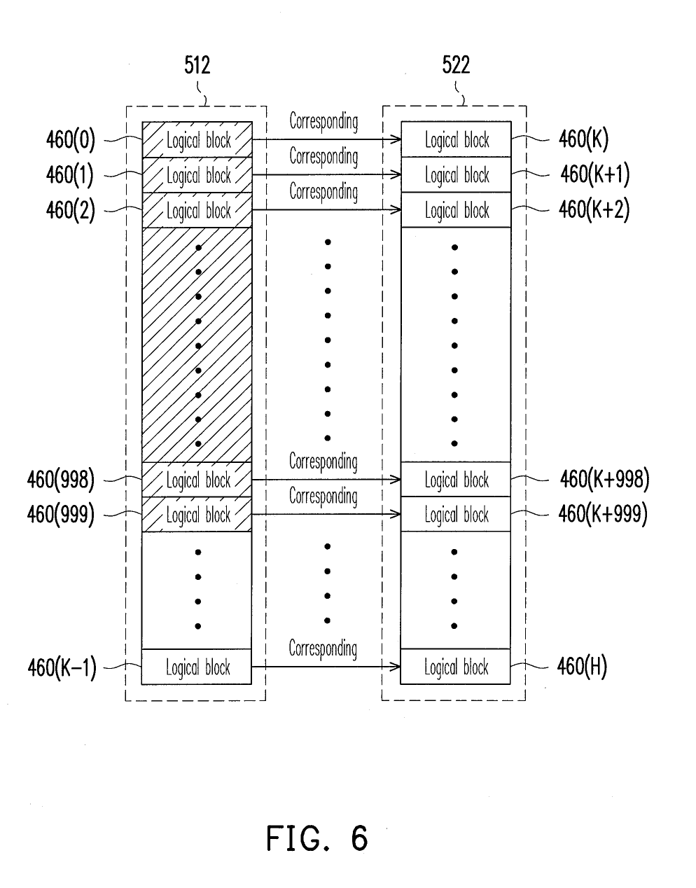

FIG. 6 illustrates an example of writing data according to the exemplary embodiment of the present invention.

Referring to FIG. 6, if the storage area 304 does not contain any data and the storage mode of the primary memory area 512 is set to the writable mode, when a computer administrator installs an operation system (OS) or an application program or writes data (e.g., initial data) into the storage device 100 through the host system 1000, the storage medium management circuit 204 writes the data into the logical blocks 460(0)-460(999) of the primary memory area 512 according to the write command. Particularly, in order to prevent the system settings from being falsified after the OS or the application program is installed, the computer administrator sends a control command which requests the storage mode of the primary memory area 512 to be set to the write-protect mode to the storage device 100 through the host system 1000, and the storage medium management circuit 204 sets the storage mode of the primary memory area 512 to the write-protect mode according to the control command.

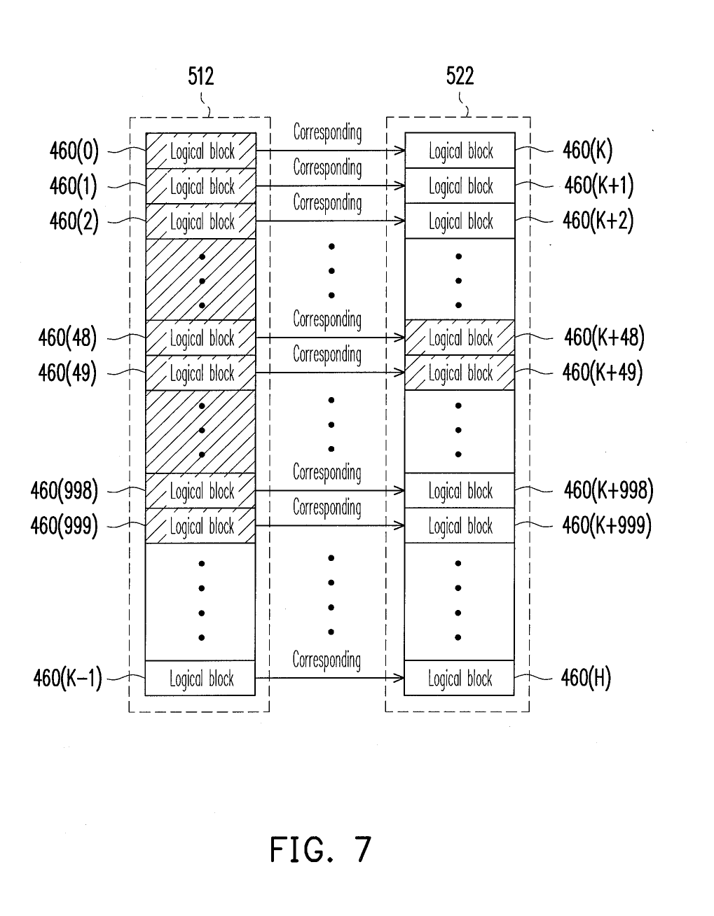

FIG. 7 illustrates another example of writing data according to the exemplary embodiment of the present invention.

Referring to FIG. 7, if it is under the status illustrated in FIG. 6 and the storage mode of the primary memory area 512 is set to the write-protect mode, when the host system 1000 is about to update the data in the logical blocks 460(48)-460(49) of the primary memory area 512 (i.e., write update data into the logical blocks 460(48)-460(49) of the primary memory area 512), the storage medium management circuit 204 writes the update data into the corresponding logical blocks 460(K+48)-460(K+49) of the temporary memory area 522.

In particular, under the status illustrated in FIG. 6, when the host system 1000 is about to read the data in the logical blocks 460(0)-460(47) or the logical blocks 460(50)-460(999) of the primary memory area 512, the storage medium management circuit 204 identifies that no update data corresponding to the logical blocks 460(0)-460(47) and the logical blocks 460(50)-460(999) is stored in the temporary memory area 522. Then, the storage medium management circuit 204 reads the corresponding data from the logical blocks of the primary memory area 512 and sends the read data to the host system 1000. In addition, when the host system 1000 is about to read the data in the logical blocks 460(48)-460(49) of the primary memory area 512, the storage medium management circuit 204 identifies that the update data corresponding to the logical blocks 460(48)-460(49) is stored in the temporary memory area 522. Then, the storage medium management circuit 204 reads the corresponding data from the logical blocks 460(K+48)-460(K+49) of the temporary memory area 522 and sends the read data to the host system 1000.

In the present exemplary embodiment, in the case that the storage mode of the primary memory area 512 is set to the write-protect mode, the storage medium management circuit 204 establishes and maintains an address corresponding table to record the update information corresponding to the logical blocks of the primary memory area 512.

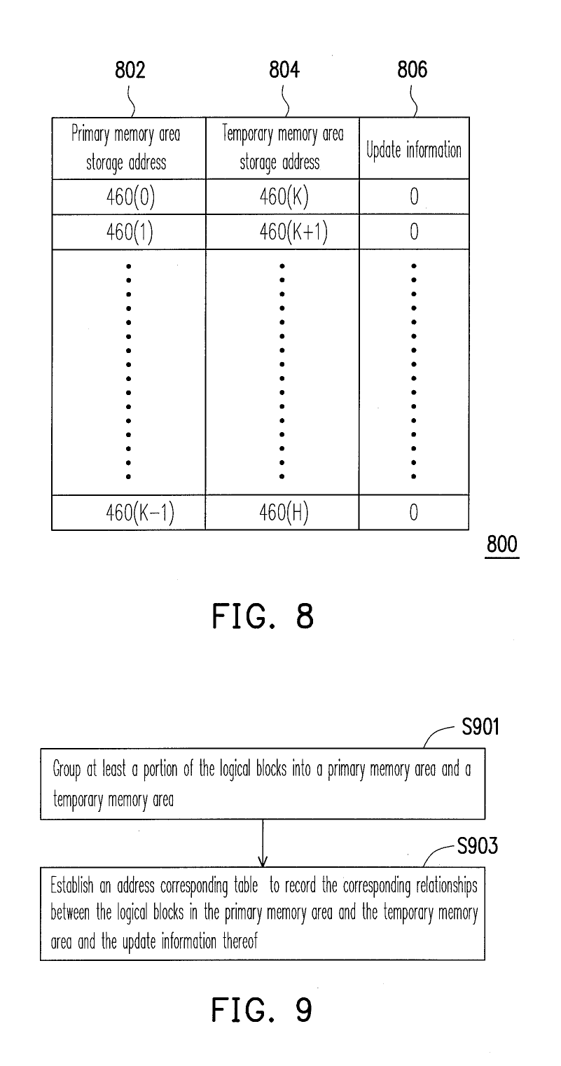

FIG. 8 illustrates an example of an address corresponding table according to an exemplary embodiment of the present invention.

Referring to FIG. 8, the address corresponding table 800 includes a primary memory area storage address field 802, a temporary memory area storage address field 804, and an update information field 806. The temporary memory area storage address field 804 records the temporary addresses corresponding to the logical blocks in the primary memory area storage address field 802. The update information field 806 records the information indicating whether the data stored in the logical blocks of the primary memory area 512 is updated. For example, when a value “1” is recorded in the update information field 806, it represents that the data stored in the logical block recorded in the primary memory area storage address field 802 is updated. Contrarily, when a value “0” is recorded in the update information field 806, it represents that the data stored in the logical block recorded in the primary memory area storage address field 802 is not updated. Namely, when a logical block in the temporary memory area 522 is already used for storing update data that is used for updating the data stored in the primary memory area 512, the storage medium management circuit 204 marks the update information of the logical block in the update information field 806 of the address corresponding table 800 so as to indicate that the data stored in the primary memory area 512 has been updated. It should be understood that even though whether the data is updated is indicated with a value “1” or “0” in the present exemplary embodiment, the present invention is not limited thereto, and whether the data is updated may also be indicated with other symbols or words.

It should be mentioned that when the storage device 100 is re-started (for example, the storage device 100 is powered off and then re-coupled to the host system 1000), the storage medium management circuit 204 erases the update information recorded in the address corresponding table 800. For example, the storage medium management circuit 204 resets all values in the update information field 806 to the value “0” to indicate that no update data is stored in the temporary memory area 522. Thus, the data accessed by the host system 1000 is always recovered to the initial data every time when the storage device 100 is re-started. Namely, the operation environment and system settings of the host system 1000 are always recovered to the state before the storage mode of the primary memory area 512 is set to the write-protect mode every time when the host system 1000 is boot up. For example, after the computer administrator installs an OS or an application program in the primary memory area 512 and sets the storage mode of the primary memory area 512 to the write-protect mode, the host system 1000 is always boot up according to the originally installed OS or application program whenever a user re-starts the host system 1000.

It should be mentioned that in the present exemplary embodiment, the capacity of the primary memory area 512 is the same as that of the temporary memory area 522, and the logical blocks in the temporary memory area 522 are served as the temporary addresses of the logical blocks in the primary memory area 512 in a one-to-one manner (i.e., each of the temporary addresses is corresponding to one of the storage addresses of primary memory area 512). However, the present invention is not limited thereto, and in another exemplary embodiment of the present invention, the capacity of the temporary memory area 522 may also be smaller than that of the primary memory area 512, and the logical blocks in the temporary memory area 522 may be alternatively used for storing update data from the host system 1000.

FIG. 9 is a flowchart illustrating the steps of dividing the storage medium and establishing an address corresponding table in a system recovery method according to the exemplary embodiment of the present invention.

Referring to FIG. 9, when the storage device 100 is initialized (for example, formatted), in step S901, the storage medium management circuit 204 groups at least a portion of the logical blocks into the primary memory area 512 and the temporary memory area 522.

In step S903, the storage medium management circuit 204 establishes the address corresponding table 800 to record the corresponding relationships between the logical blocks in the primary memory area 512 and the logical blocks in the temporary memory area 522 and the update information of these logical blocks.

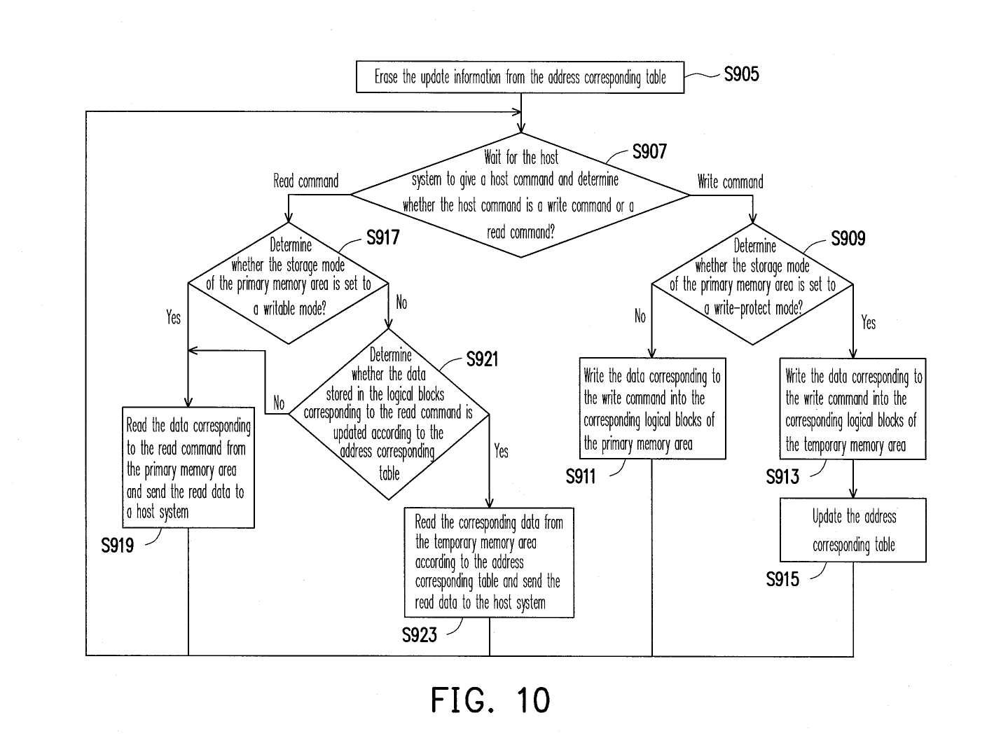

FIG. 10 is a flowchart illustrating the steps of writing and reading data in a system recovery method according to an exemplary embodiment of the present invention.

Referring to FIG. 10, when the storage device 100 is coupled to the host system 1000, first, in step S905, the storage medium management circuit 204 erases the update information in the address corresponding table 800.

Then, in step S907, the storage medium management circuit 204 waits for the host system 1000 to give a host command and determines whether the host command is a write command or a read command.

If it is determined in step S907 that the host command is the write command, in step S909, the storage medium management circuit 204 determines whether the storage mode of the primary memory area 512 is set to the write-protect mode. If the storage mode of the primary memory area 512 is not set to the write-protect mode, in step S911, the storage medium management circuit 204 writes the data corresponding to the write command into the corresponding logical blocks of the primary memory area 512. If the storage mode of the primary memory area 512 is set to the write-protect mode, in step S913, the storage medium management circuit 204 writes the data corresponding to the write command into the corresponding logical blocks of the temporary memory area 522, and in step S915, the storage medium management circuit 204 updates the address corresponding table 800.

If it is determined in step S907 that the host command is the read command, in step S917, the storage medium management circuit 204 determines whether the storage mode of the primary memory area 512 is set to the writable mode. If the storage mode of the primary memory area 512 is set to the writable mode, in step S919, the storage medium management circuit 204 reads the data corresponding to the read command from the primary memory area 512 and sends the read data to the host system 1000. If the storage mode of the primary memory area 512 is not set to the writable mode, in step S921, the storage medium management circuit 204 determines whether the data stored in the logical blocks corresponding to the read command is updated according to the address corresponding table 800.

If the data stored in the logical blocks corresponding to the read command is not updated, then step S919 is executed. If the data stored in the logical blocks corresponding to the read command is updated, in step S923, the storage medium management circuit 204 reads the corresponding data from the temporary memory area 522 according to the address corresponding table 800 and sends the read data to the host system 1000. After steps S911, S915, S919, and S923, the storage medium management circuit 204 executes step S907 to wait for the next host command. Besides, the procedure illustrated in FIG. 10 is terminated when the storage device 100 is powered off.

As described above, in the system recovery method provided by the exemplary embodiment of the present invention, the storage space of a storage device is divided into a primary memory area and a temporary memory area. When the storage mode of the primary memory area is set to a write-protect mode, the data from a host system is stored in the temporary memory area, and the update information is recorded in an address corresponding table. In addition, when the storage device is re-started, the update information in the address corresponding table is erased so that the host system always accesses the data stored before the storage mode of the primary memory area is set to the write-protect mode. Thereby, in the exemplary embodiment of the present invention, data in the primary memory area is effectively prevented from being falsified, and system settings can be instantly recovered to the initial state when the storage device is re-started. The previously described exemplary embodiments of the present invention have the advantages aforementioned, wherein the advantages aforementioned not required in all versions of the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system recovery method, for a storage device, the system recovery method comprising:
grouping a plurality of storage addresses corresponding to the storage device into at least a first memory area and a second memory area;
receiving at least a first write command and a first data from a host system;
writing the first data into the storage addresses of the second memory area when the first data is to be written into the storage addresses of the first memory area;
establishing an address corresponding table to record an update information corresponding to the storage addresses storing the first data; and
erasing the update information from the address corresponding table when the storage device is powered off and re-coupled to the host system.

2. The system recovery method according to claim 1 further comprising:
receiving a first read command from the host system, and determining whether the update information corresponding to the storage addresses to be read by the first read command is stored in the address corresponding table;
reading data corresponding to the first read command from the first memory area and sending the read data corresponding to the first read command to the host system when the update information corresponding to the storage addresses to be read by the first read command is not stored in the address corresponding table; and
reading the data corresponding to the first read command from the second memory area according to the update information and sending the read data corresponding to the first read command to the host system when the update information corresponding to the storage addresses to be read by the first read command is stored in the address corresponding table.

3. The system recovery method according to claim 1, wherein a storage mode of the first memory area is a write-protect mode, and the system recovery method further comprises:
setting the storage mode of the first memory area to a writable mode from the write-protect mode according to a control command of the host system.

4. The system recovery method according to claim 3 further comprising:
writing an initial data from the host system into the storage addresses of the first memory area; and
after writing the initial data into the storage addresses of the first memory area, setting the storage mode of the first memory area to the write-protect mode from the writable mode according to the control command of the host system.

5. The system recovery method according to claim 4, wherein before the step of setting the storage mode of the first memory area to the writable mode from the write-protect mode according to the control command of the host system, the system recovery method further comprises:
receiving a second read command for reading the storage addresses of the first memory area from the host system, and determining whether the update information corresponding to the storage addresses to be read by the second read command is stored in the address corresponding table;
reading data corresponding to the second read command from the first memory area and sending the read data corresponding to the second read command to the host system when the update information corresponding to the storage addresses to be read by the second read command is not stored in the address corresponding table; and
reading the data corresponding to the second read command from the second memory area according to the update information and sending the read data corresponding to the second read command to the host system when the update information corresponding to the storage addresses to be read by the second read command is stored in the address corresponding table; and
wherein after the step of writing the initial data from the host system into the storage addresses of the first memory area, the system recovery method further comprises:
receiving a third read command for reading the storage addresses of the first memory area from the host system;
reading data corresponding to the third read command from the first memory area; and
sending the read data corresponding to the third read command to the host system.

6. The system recovery method according to claim 3 further comprising:
receiving a second write command and a second data corresponding to the second write command from the host system, and writing the second data into the first memory area.

7. The system recovery method according to claim 1, wherein the step of grouping the storage addresses into at least the first memory area and the second memory area comprises:
grouping at least a portion of the storage addresses into the first memory area and the second memory area having the same capacity; and
serving the storage addresses of the second memory area as a plurality of temporary addresses respectively corresponding to the storage addresses of the first memory area, wherein each of the temporary addresses is corresponding to one of the storage addresses of the first memory area.

8. The system recovery method according to claim 7, wherein the step of writing the first data into the storage addresses of the second memory area comprises:
storing the first data into the temporary addresses corresponding to the storage addresses storing the first data.

9. A storage medium controller, for managing a storage medium unit of a storage device, the storage medium controller comprising:
a host interface, configured to couple to a host system;
a storage medium interface, configured to couple to the storage medium unit; and
a storage medium management circuit, coupled to the host interface and the storage medium interface and configured to:
group a plurality of storage addresses corresponding to storage medium unit into at least a first memory area and a second memory area;
receive at least a first write command and a first data from the host system;
write the first data into the storage addresses of the second memory area when the first data is to be written into the storage addresses of the first memory area;
establish an address corresponding table to record an update information corresponding to the storage addresses storing the first data; and
erase the update information from the address corresponding table when the storage device is powered off and re-coupled to the host system.

10. The storage medium controller according to claim 9,
wherein the storage medium management circuit is further configured to receive a first read command from the host system and determine whether the update information corresponding to the storage addresses to be read by the first read command is stored in the address corresponding table,
wherein when the update information is not stored in the address corresponding table, the storage medium management circuit reads data corresponding to the first read command from the first memory area and sends the read data corresponding to the first read command to the host system, and
wherein when the update information is stored in the address corresponding table, the storage medium management circuit reads the data corresponding to the first read command from the second memory area according to the update information and sends the read data corresponding to the first read command to the host system.

11. The storage medium controller according to claim 9, wherein a storage mode of the first memory area is a write-protect mode, and the storage medium management circuit is further configured to set the storage mode of the first memory area to a writable mode from the write-protect mode according to a control command of the host system.

12. The storage medium controller according to claim 11, wherein the storage medium management circuit is further configured to write an initial data from the host system into the storage addresses of the first memory area, and after writing the initial data into the storage addresses of the first memory area, the storage medium management circuit sets the storage mode of the first memory area to the write-protect mode from the writable mode according to the control command of the host system.

13. The storage medium controller according to claim 12,
wherein before setting the storage mode of the first memory area to the writable mode from the write-protect mode according to the control command of the host system, the storage medium management circuit is further configured to receive a second read command for reading the storage addresses of the first memory area from the host system and determine whether the update information corresponding to the storage addresses to be read by the second read command is stored in the address corresponding table,
wherein when the update information corresponding to the storage addresses to be read by the second read command is not stored in the address corresponding table, the storage medium management circuit is further configured to read data corresponding to the second read command from the first memory area and send the read data corresponding to the second read command to the host system,
wherein when the update information corresponding to the storage addresses to be read by the second read command is stored in the address corresponding table, the storage medium management circuit is further configured to read the data corresponding to the second read command from the second memory area according to the update information and send the read data corresponding to the second read command to the host system,
wherein after writing the initial data from the host system into the storage addresses of the first memory area, the storage medium management circuit is further configured to receive a third read command for reading the storage addresses of the first memory area from the host system, read data corresponding to the third read command from the first memory area, and send the read data corresponding to the third read command to the host system.

14. The storage medium controller according to claim 11,
wherein the storage medium management circuit is further configured to receive a second write command and a second data corresponding to the second write command from the host system and write the second data into the first memory area.

15. The storage medium controller according to claim 9,
wherein the storage medium management circuit is further configured to serve the storage addresses of the second memory area as a plurality of temporary addresses respectively corresponding to the storage addresses of the first memory area, wherein a capacity of the first memory area is the same as a capacity of the second memory area, and each of the temporary addresses is corresponding to one of the storage addresses of the first memory area.

16. The storage medium controller according to claim 15, wherein the storage medium management circuit is further configured to store the first data into the temporary addresses corresponding to the storage addresses storing the first data.

17. The storage medium controller according to claim 9, wherein the storage medium unit is a rewritable non-volatile memory chip, the storage addresses are mapped to a plurality of physical blocks of the rewritable non-volatile memory chip, each of the physical blocks has a plurality of physical pages, and the physical pages belonging to the same physical block are individually written and simultaneously erased.

18. A storage system, comprising:
a connector, configured to couple to a host system;
a storage medium unit; and
a storage medium controller, coupled to the storage medium unit and the connector and configured to:
group a plurality of storage addresses corresponding to the storage medium unit into at least a first memory area and a second memory area;
receive at least a first write command and a first data from a host system;
write the first data into the storage addresses of the second memory area when the first data is to be written into the storage addresses of the first memory area;
establish an address corresponding table to record an update information corresponding to the storage addresses storing the first data; and
erase the update information from the address corresponding table when the storage system is powered off and re-coupled to the host system.

19. The storage system according to claim 18,
wherein the storage medium controller is further to receive a first read command from the host system and determine whether the update information corresponding to the storage addresses to be read by the first read command is stored in the address corresponding table,
wherein when the update information is not stored in the address corresponding table, the storage medium controller is further configured to read data corresponding to the first read command from the first memory area and send the read data corresponding to the first read command to the host system, and
wherein when the update information is stored in the address corresponding table, the storage medium controller is further configured to read the data corresponding to the first read command from the second memory area according to the update information and send the read data corresponding to the first read command to the host system.

20. The storage system according to claim 18, wherein a storage mode of the first memory area is a write-protect mode, and the storage medium controller is further configured to set the storage mode of the first memory area to a writable mode from the write-protect mode according to a control command of the host system.

21. The storage system according to claim 20, wherein the storage medium controller is further configured to write an initial data from the host system into the storage addresses of the first memory area, and after writing the initial data into the storage addresses of the first memory area, the storage medium controller sets the storage mode of the first memory area to the write-protect mode from the writable mode according to the control command of the host system.

22. The storage system according to claim 21,
wherein before setting the storage mode of the first memory area to the writable mode from the write-protect mode according to the control command of the host system, the storage medium controller is further configured to receive a second read command for reading the storage addresses of the first memory area from the host system and determine whether the update information corresponding to the storage addresses to be read by the second read command is stored in the address corresponding table,
wherein when the update information corresponding to the storage addresses to be read by the second read command is not stored in the address corresponding table, the storage medium controller is further configured to read data corresponding to the second read command from the first memory area and send the read data corresponding to the second read command to the host system,
wherein when the update information corresponding to the storage addresses to be read by the second read command is stored in the address corresponding table, the storage medium controller is further configured to read the data corresponding to the second read command from the second memory area according to the update information and send the read data corresponding to the second read command to the host system,
wherein after writing the initial data into the storage addresses of the first memory area, the storage medium controller is further configured to receive a third read command for reading the storage addresses of the first memory area from the host system, read data corresponding to the third read command from the first memory area, and send the data corresponding to the third read command to the host system.

23. The storage system according to claim 20,
wherein the storage medium controller is further configured to receive a second write command and a second data corresponding to the second write command from the host system and write the second data into the first memory area.

24. The storage system according to claim 18,
wherein the storage medium controller is further configured to serve the storage addresses of the second memory area as a plurality of temporary addresses respectively corresponding to the storage addresses of the first memory area, wherein a capacity of the first memory area is the same as a capacity of the second memory area, and each of the temporary addresses is corresponding to one of the storage addresses of the first memory area.

25. The storage system according to claim 24, wherein the storage medium controller is further configured to store the first data into the temporary addresses corresponding to the storage addresses storing the first data.
